(19) United States
(12) Patent Application Publication
(10) Pub. No.: US 2024/0265325 A1
(43) Pub. Date: Aug. 8, 2024

(54) WORKLOAD ANALYSIS DEVICE

(71) Applicant: TOYOTA JIDOSHA KABUSHIKI KAISHA, Toyota-shi (JP)

(72) Inventors: Hirofumi MORISHITA, Toyota-shi (JP); Toshiyuki ISHIHARA, Tokyo (JP)

(73) Assignee: TOYOTA JIDOSHA KABUSHIKI KAISHA, Toyota-shi (JP)

(21) Appl. No.: 18/434,334

(22) Filed: Feb. 6, 2024

(30) Foreign Application Priority Data
Feb. 7, 2023 (JP) 2023-017204

(51) Int. Cl. G06Q 10/0633; G06T 11/20; G06V 10/62; G06V 10/82; G06V 40/10

(52) U.S. Cl. CPC G06Q 10/0633; G06T 11/206; G06V 10/62; G06V 10/82; G06V 40/10

(57) ABSTRACT

A workload analysis device includes: a workpiece detecting unit configured to recognize a process segment in which a worker is working by detecting a workpiece which is a work object in an image of a work flow such as a production line or a fixing or repairing line captured by a camera and acquired via an image acquiring unit; and a worker detecting unit configured to detect a worker in the process segment in the image of the work flow acquired in a time series.

### CROSS-REFERENCE TO RELATED APPLICATION

This application claims priority to Japanese Patent Application No. 2023-017204 filed on Feb. 7, 2023, incorporated herein by reference in its entirety.

### BACKGROUND

### 1. Technical Field

The present disclosure relates to a workload analysis device that detects a workpiece in a work flow such as a production line or a fixing or repairing line in which a workpiece (a vehicle body) which is a work object flows such as a vehicle assembly process and identifies a plurality of workers working in the vicinity of the workpiece.

### 2. Description of Related Art

In processing a work flow including a plurality of work segments, there is need for appropriately assigning work such that a load is not concentrated on a specific process.

Japanese Unexamined Patent Application Publication No. 2021-125183 (JP 2021-125183 A) discloses a technique of determining that work starts when a worker enters a predetermined area (a first area) and determining that the work ends when the worker enters another predetermined area (a second area).

However, in the technique described in JP 2021-125183 A, a method of setting the first area and the second area is not described, and there is concern that determination of working and determination of work end when a work area varies will not be able to be accurately performed.

### SUMMARY

The present disclosure provides a workload analysis device that can accurately identify a plurality of workers working in a work area in a work flow.

According to a first aspect of the present disclosure, there is provided a workload analysis device including: a workpiece detecting unit configured to recognize a process segment in which a worker is working by detecting a work object in an image of a work flow which is acquired in a time series by an imaging device; and a worker detecting unit configured to detect a worker in the process segment in the image of the work flow acquired in a time series.

With the workload analysis device according to the first aspect, it is possible to recognize a process segment in which a worker is working in the image of the work flow and to detect the worker in the process segment.

In the workload analysis device according to a second aspect, the workpiece detecting unit may be configured to recognize as the process segment a segment after a head of a predetermined area including the work object has reached a predetermined position set to be perpendicular to a flow direction of the workpiece in the work flow and until a rear end of the predetermined area reaches the predetermined position in the image of the work flow acquired in a time series.

With the workload analysis device according to the second aspect, when the head and the rear end of the predetermined area including a work object reach the predetermined position of the work flow, it is possible to recognize the process segment in which a worker is working.

In the workload analysis device according to a third aspect, the worker detecting unit may be configured to store a time over which the worker is detected in the image of the work flow acquired in a time series as a worktime of the worker in the process segment in a storage unit.

With the workload analysis device according to the third aspect, the time over which a worker is detected in the image is set as the worktime.

In the workload analysis device according to a fourth aspect, the worker detecting unit may be configured to store the number of workers detected in the image of the work flow acquired in a time series and worktimes of the workers detected by recognizing identifiers added to the plurality of workers in the image of the work flow acquired in a time series in the storage unit.

With the workload analysis device according to the fourth aspect, it is possible to detect worktimes of a plurality of workers.

The workload analysis device according to a fifth aspect may further include a graph generating and displaying unit configured to generate a graph in which workloads in the process segment are visualized based on the worktimes of the workers and the number of workers stored in the storage unit and to output the generated graph to a display device.

With the workload analysis device according to the fifth aspect, it is possible to visually display a workload in a process segment.

As described above, with the workload analysis device according to the present disclosure, it is possible to accurately identify a plurality of workers working in a work area in a work flow.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram illustrating an example of a configuration of a workload analysis device according to an embodiment;

FIG. 2 is a flowchart illustrating an example of a process flow that is performed by the workload analysis device according to the embodiment;

FIG. 3A is a diagram schematically illustrating a case in which a head of a workpiece has reached a predetermined position in a work flow;

FIG. 3B is a diagram schematically illustrating a case in which a rear end of a workpiece has reached the predetermined position in a work flow;

FIG. 4 is a graph illustrating an example of change of the number of workers in a time series in process segments; and

FIG. 5 is a graph illustrating an example of a result of workload analysis of a plurality of workers in process segments.

### DETAILED DESCRIPTION OF EMBODIMENTS

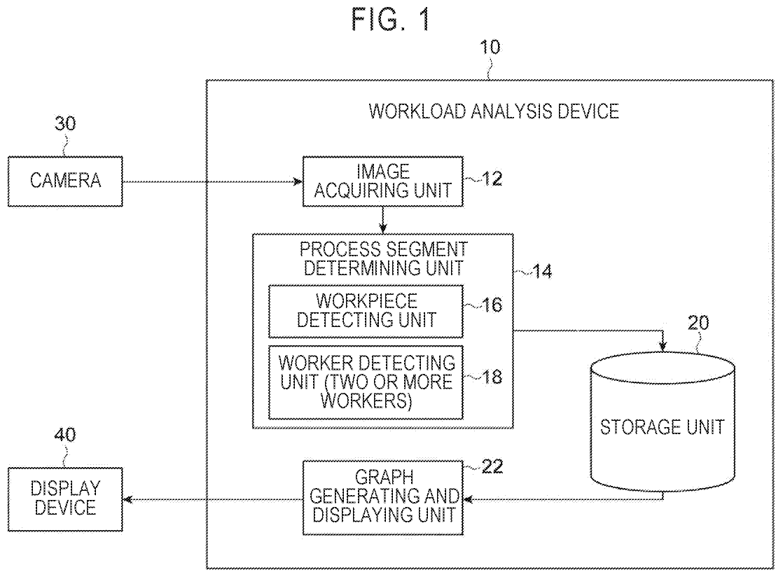

Hereinafter, a workload analysis device 10 according to an embodiment will be described with reference to FIG. 1. The workload analysis device 10 includes an image acquiring unit 12, a process segment determining unit 14, a graph generating and displaying unit 22, and a storage unit 20. The image acquiring unit 12 acquires an image from a camera 30. The process segment determining unit 14 detects a worker who is working on the basis of an image of a work flow such as a production line or a fixing or repairing line acquired in a time series by the camera 30 and stores a result of detection in the storage unit 20. The process segment determining unit 14 includes a workpiece detecting unit 16 and a worker detecting unit 18. The workpiece detecting unit 16 detects presence of a workpiece in a work area in the image acquired from the camera 30. The worker detecting unit 18 detects presence of a worker in the image acquired from the camera 30. The graph generating and displaying unit 22 generates a graph for visualizing a workload of each process segment on the basis of information indicating presence of a worker stored in the storage unit 20 and displays the generated graph on a display device 40.

The workload analysis device 10 is a kind of computer, the image acquiring unit 12 corresponds to an input interface, the process segment determining unit 14 corresponds to a central processing unit (CPU) and a graphics processing unit (GPU), the storage unit 20 corresponds to a nonvolatile memory such as a hard disk drive (HDD), and the graph generating and displaying unit 22 corresponds to an output device. As will be described later, the process segment determining unit 14 is configured to detect presence of a workpiece and presence of a worker in an image by machine learning and serves as the workpiece detecting unit 16 and the worker detecting unit 18 through the machine learning.

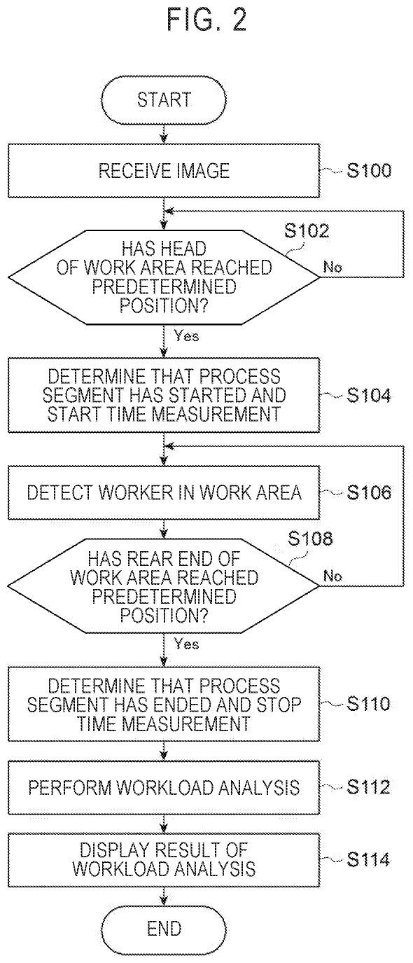

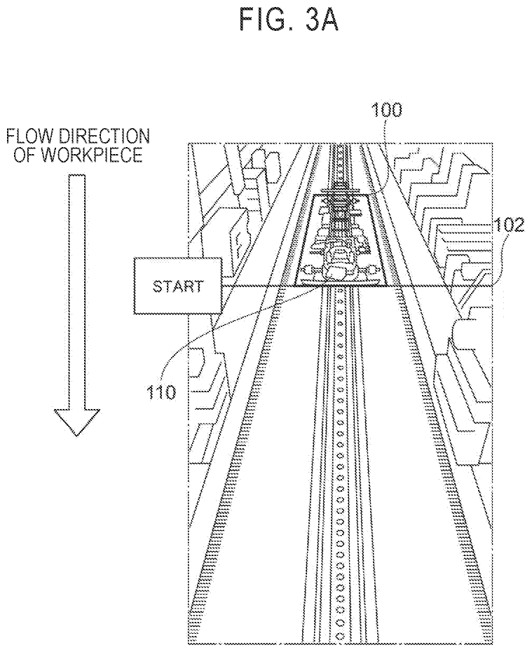

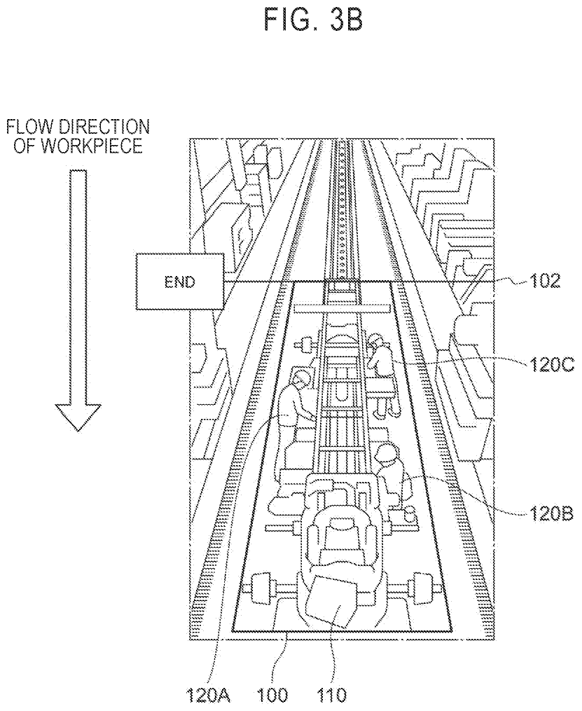

FIG. 2 is a flowchart illustrating an example of a process flow that is performed by the workload analysis device 10 according to the embodiment. In Step S100, the image acquiring unit 12 acquires an image captured by the camera 30. FIGS. 3A and 3B illustrate examples of the image acquired by the image acquiring unit 12. In this embodiment, for example, the camera 30 includes a wide-angle lens and is installed to overlook a work flow.

In Step S102, the workpiece detecting unit 16 of the process segment determining unit 14 determines whether a head of a work area 100 has reached a predetermined position 102 which is set to be perpendicular to a flow direction of a workpiece 110 in a work flow. The process flow proceeds to Step S104 when it is determined in Step S102 that the head of the work area 100 which is a predetermined range including the workpiece 110 has reached the predetermined position 102 as illustrated in FIG. 3A, and the determination of Step S102 is repeatedly performed when the head of the work area 100 has not reached the predetermined position 102. In this embodiment, as illustrated in FIGS. 3A and 3B, the workpiece 110 is, for example, a chassis of a large-sized vehicle such as a truck.

In Step S104, the process segment determining unit 14 determines that a process segment has started and starts time measurement.

In this embodiment, through machine learning using a mathematical model such as a convolutional neural network (CNN) or a recurrent neural network (RNN), the process segment determining unit 14 is configured in advance to perform recognition of a shape of the workpiece 110, recognition of the head of the work area 100 having reached the predetermined position 102, recognition of the rear end of the work area 100 having reached the predetermined position 102, and detection of workers 120A, 120B, and 120C in the work area 100. The process segment determining unit 14 having been subjected to the machine learning performs recognition of a shape of the workpiece 110, recognition of the head of the work area 100 having reached the predetermined position 102, and recognition of the rear end of the work area 100 having reached the predetermined position 102 using the workpiece detecting unit 16. The process segment determining unit 14 having been subjected to the machine learning detects presence of the workers 120A, 120B, and 120C in the work area 100 using the worker detecting unit 18.

In Step S106, the worker detecting unit 18 of the process segment determining unit 14 detects the workers 120A, 120B, and 120C in the work area 100. The worker detecting unit 18 detects times in which the workers 120A, 120B, and 120C in the work area 100 are detected. The worker detecting unit 18 may identify a plurality of workers 120A, 120B, and 120C, but since the workers 120A, 120B, and 120C wear helmets in the work flow, the workers may not be able to be identified accurately by facial recognition. In this embodiment, the workers 120A, 120B, and 120C are identified in an image using identifiers added in advance to the workers 120A, 120B, and 120C. The identifiers employ colors of helmets or work clothes of the workers 120A, 120B, and 120C which are different from each other or employ identifiable information such as characters or symbols added in advance to the helmets or the work clothes of the workers 120A, 120B, and 120C.

In Step S108, the workpiece detecting unit 16 of the process segment determining unit 14 determines whether the rear end of the work area 100 has reached the predetermined position 102. The process flow proceeds to Step S110 when it is determined in Step S108 that the rear end of the work area 100 has reached the predetermined position 102 as illustrated in FIG. 3B, and the determination of Step S108 is repeatedly performed when it is determined that the rear end of the work area 100 has not reached the predetermined position 102.

In Step S110, the process segment determining unit 14 determines that the process segment has ended and stops the time measurement started in Step S104. In this embodiment, the time clocked from Step S104 to Step S110 is a total worktime in the work area 100, that is a worktime required for the process segment.

In Step S112, the process segment determining unit 14 performs workload analysis. Through the workload analysis, a worktime required for process segments, change in the number of workers in a time series in process segments, and worktimes of a plurality of workers 120A, 120B, and 120C are calculated. Then, the process segment determining unit 14 stores the calculated worktime required for process segments, the calculated change of the number of workers in a time series in process segments, and the calculated worktimes of the workers 120A, 120B, and 120C in the storage unit 20.

In Step S114, the graph generating and displaying unit 22 displays a result of workload analysis based on the worktime required for process segments, the change of the number of workers in a time series in process segments, and the worktimes of the workers 120A, 120B, and 120C stored in the storage unit 20 on the display device 40 and then ends the process flow.

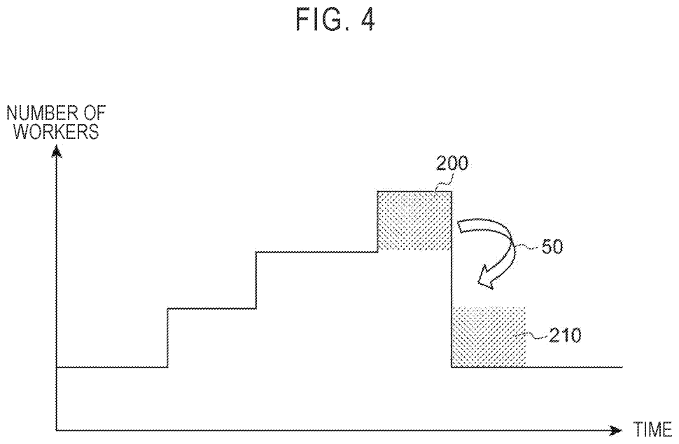

FIG. 4 is a graph illustrating an example of change in the number of workers in a time series in process segments. When there is a process segment 200 in which the number of workers is exceptionally large as illustrated in FIG. 4, it is possible to improve a case in which the number of workers is exceptionally large by checking up on work details ends in the process segments and to assign the workers to another process segment 210 as indicated by an arrow 50.

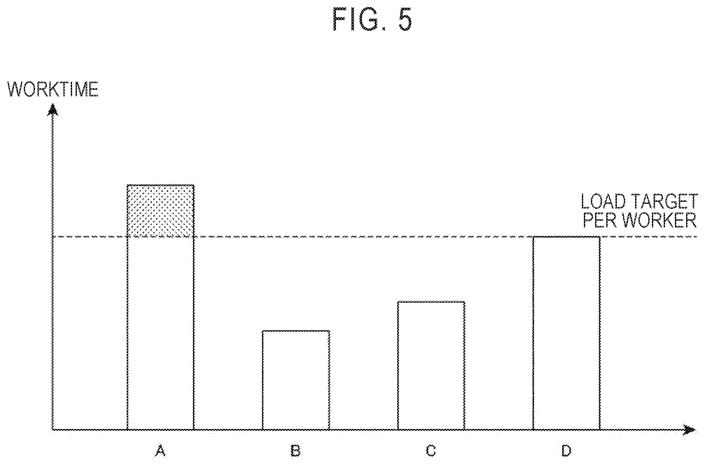

FIG. 5 is a graph illustrating a result of workload analysis in process segments of workers A, B, C, and D. When the worktime of the worker A is greater than a load target per worker as illustrated in FIG. 5, measures of assigning a part of the workload of the worker A to the worker B or the worker C or the like can be taken.

As described above, with the workload analysis device 10 according to the embodiment, it is possible to recognize a process segment in which a worker is working in an image of a work flow such as a production line or a fixing or repairing line and to accurately identify a plurality of workers working in a work area 100 in the work flow by detecting the workers in the process segments.

With the workload analysis device 10 according to the embodiment, it is possible to contribute to appropriate setting of a work process and optimization of work assignment of workers by generating and displaying a graph in which workloads in process segments are visualized based on worktimes of workers and the number of workers in the process segments.

What is claimed is:

1. A workload analysis device comprising:
a workpiece detecting unit configured to recognize a process segment in which a worker is working by detecting a work object in an image of a work flow which is acquired in a time series by an imaging device; and
a worker detecting unit configured to detect a worker in the process segment in the image of the work flow acquired in a time series.

2. The workload analysis device according to claim 1, wherein the workpiece detecting unit is configured to recognize as the process segment a segment after a head of a predetermined area including the work object has reached a predetermined position set to be perpendicular to a flow direction of the workpiece in the work flow and until a rear end of the predetermined area reaches the predetermined position in the image of the work flow acquired in a time series.

3. The workload analysis device according to claim 1, wherein the worker detecting unit is configured to store a time over which the worker is detected in the image of the work flow acquired in a time series as a worktime of the worker in the process segment in a storage unit.

4. The workload analysis device according to claim 3, wherein the worker detecting unit is configured to store the number of workers detected in the image of the work flow acquired in a time series and worktimes of the workers detected by recognizing identifiers added to the plurality of workers in the image of the work flow acquired in a time series in the storage unit.

5. The workload analysis device according to claim 4, further comprising a graph generating and displaying unit configured to generate a graph in which workloads in the process segment are visualized based on the worktimes of the workers and the number of workers stored in the storage unit and to output the generated graph to a display device.
